(19) United States
(12) Patent Application Publication
(10) Pub. No.: US 2011/0131664 A1
(43) Pub. Date: Jun. 2, 2011

(54) CONTENT AGING

(75) Inventor: Håkan Lars Emanuel Jonsson, Hjarup (SE)

(73) Assignee: SONY ERICSSON MOBILE COMMUNICATIONS AB, Lund (SE)

(21) Appl. No.: 12/628,352

(22) Filed: Dec. 1, 2009

(51) Int. Cl. G06F 21/24; G06F 3/048

(52) U.S. Cl. 726/28; 715/847

(57) ABSTRACT

A device includes a memory to store instructions; and a processor to execute the instructions to determine that access rights, associated with a particular user in relation to particular content, have expired; degrade an appearance of the particular content or a representation of the particular content, where the degradation is amplified over a grace period that commences upon the expiration of the access rights, in response to determining that the access rights have expired; determine that the grace period associated with the expired access rights has ended; and end access to the particular content, in response to determining that the grace period has ended.

### BACKGROUND

Digital rights management (DRM) allows content owners to control access to specific content. For example, a manufacturer, a publisher, an author, or a copyright owner may specify how long a user (or a group of users) has access to specific documents, images, audio or video files, or software applications. When the user's rights expire, the user may lose access to the content or the user may be prompted that the content is no longer accessible. Additionally, a user (or a group of users) may have access to content that may not be protected by DRM, but may nevertheless be time-sensitive. In other words, the value of the time-sensitive content may decrease after a particular length of time. Users may find the experience of discovering loss of access rights to content protected by DRM particularly unpleasant.

### SUMMARY

According to one aspect, a device may include a memory to store instructions; and a processor to execute the instructions to determine that access rights, associated with a particular user in relation to particular content, have expired; degrade an appearance of the particular content or a representation of the particular content, where the degradation is amplified over a grace period that commences upon the expiration of the access rights, in response to determining that the access rights have expired; determine that the grace period associated with the expired access rights has ended; and end access to the particular content, in response to determining that the grace period has ended.

Additionally, the processor may be to degrade the particular content in response to the particular user accessing the particular content.

Additionally, the particular content may include at least one of a document, an image, an audio file, or a video file.

Additionally, degrading an appearance of the particular content or a representation of the particular content may include degrading the representation of the particular content, where the representation of the particular content includes at least one of an icon associated with the particular content or a link associated with the particular content.

Additionally, the processor may be to degrade the content based on content aging specifications associated with the particular content.

Additionally, the processor may be further to receive the content aging specifications from a content provider associated with the particular content.

Additionally, the content aging specifications may include a degradation function that includes a linear degradation function, an exponential decay degradation function, or a parabolic degradation function.

Additionally, the processor may be further to determine that time-sensitive content associated with the particular user is expired or is out of date; and degrade a representation of the time-sensitive content, where the degradation is amplified over a particular period of time, in response to determining that the time-sensitive content has expired or is out of date.

Additionally, the representation of the time-sensitive content may include one of a synchronization icon, a contacts icon, or an icon associated with a data feed.

According to another aspect, a method performed by a computer device may include determining, using a processor of the computer device, that access rights, associated with a particular user in relation to particular content, have expired; degrading, using the processor, an appearance of the particular content or a representation of the particular content, where degrading effects associated with the degrading are amplified over a grace period that commences upon the expiration of the access rights, in response to determining that the access rights have expired; determining, using the processor, that the grace period associated with the expired access rights has ended; and ending, using the processor, access to the particular content, in response to determining that the grace period has ended.

Additionally, the particular content may include at least one of a document, an image, an audio file, or a video file.

Additionally, degrading an appearance of the particular content or a representation of the particular content may include degrading the representation of the particular content, where the representation of the particular content includes at least one of an icon associated with the particular content or a link associated with the particular content.

Additionally, the method may include determining content aging specifications associated with the particular content.

Additionally, the content aging specifications may be determined based on at least one of a type of the particular content or a content provider associated with the particular content.

Additionally, the content aging specifications may include a degradation function that includes a linear degradation function, an exponential decay degradation function, or a parabolic degradation function.

Additionally, degrading the particular content or a representation of the particular content may include applying a particular image processing algorithm or a particular signal processing algorithm to the particular content or a representation of the particular content.

Additionally, the method may include determining that time-sensitive content associated with the particular user is expired or is out of date; and degrading a representation of the time-sensitive content, where the degrading is amplified over a particular period of time, in response to determining that the time-sensitive content has expired or is out of date.

Additionally, the representation of the time-sensitive content may include one of a synchronization icon, a contacts icon, or an icon associated with a data feed.

Additionally, the degrading of a representation of the time-sensitive content may include replacing the representation of the time-sensitive content with a representation of the time-sensitive content that has an aged appearance.

According to yet another aspect, one or more memory devices, storing instructions executable by one or more processors, may include one or more instructions to determine that access rights, associated with a particular user in relation to particular content, have expired; one or more instructions to degrade an appearance of the particular content or a representation of the particular content, where the degradation is amplified over a grace period that commences upon the expiration of the access rights, in response to determining that the access rights have expired; one or more instructions to determine that the grace period associated with the expired access rights has ended; and one or more instructions to end access to the particular content, in response to determining that the grace period has ended.

### BRIEF DESCRIPTION OF THE DRAWINGS

The accompanying drawings, which are incorporated in and constitute a part of this specification, illustrate one or more systems and/or methods described herein and, together with the description, explain these systems and/or methods. In the drawings:

FIG. 1 is an overview of an exemplary system in which systems and methods described herein may be implemented;

FIG. 2 is a diagram of an exemplary user device in which systems and/or methods described herein may be implemented;

FIG. 3 is a diagram illustrating exemplary components of the user device of FIG. 2;

FIG. 4 is a diagram illustrating exemplary components of a DRM system;

FIG. 5 is a diagram of exemplary functional components of the DRM system according to an implementation described herein;

FIG. 6 is a diagram of exemplary functional components of a content aging application implemented in the user device of FIG. 3;

FIG. 7 is a diagram of a first exemplary data structure according to an implementation described herein;

FIG. 8 is a diagram of a second exemplary data structure according to an implementation described herein;

FIGS. 9A-9C are diagrams of exemplary degradation functions according to implementations described herein;

FIG. 10 is a flow graph of an exemplary process for initiating degradation of content according to an implementation described herein;

FIG. 11 is a flow graph of a first exemplary process for degrading content according to an implementation described herein;

FIG. 12 is a flow graph of a second exemplary process for degrading content according to an implementation described herein;

FIG. 13 illustrates a first example of content being degraded according to an implementation described herein;

FIG. 14 illustrates a second example of content being degraded according to an implementation described herein;

FIG. 15 illustrates a third example of content being degraded according to an implementation described herein; and

FIG. 16 illustrates a fourth example of content being degraded according to an implementation described herein.

### DETAILED DESCRIPTION

The following detailed description refers to the accompanying drawings. The same reference numbers in different drawings identify the same or similar elements. Also, the following detailed description does not limit the description.

Exemplary implementations described herein may relate to applying aging effects to digital content itself or to representations of the digital content. Digital content may refer to any information that is stored electronically, magnetically, or optically on one or more memory devices. Representations of digital content may refer to, for example, an icon, a link, a button, or any other user interface object which may represent the content and which a user may select to access the content. Aging effects may be implemented, for example, by degrading an appearance of the content or by degrading a representation of the content. In one implementation, when a user's access rights to content protected by DRM expire, such as when a user's subscription to online content expires, rather than suddenly losing access to the content, a user may be provided with a grace period during which the content degrades over time. The degradation effects may be amplified during the grace period. When the grace period ends, the content may become inaccessible. Additionally or alternatively, a representation of the content, such as the icon or link representing the content, may be degraded over time.

For example, a user's access rights to a document may expire and images of pages from the document may take on a blurry appearance, which may worsen over time, and when a grace period ends, the document may become inaccessible. Alternatively, the document may worsen over time as to become unreadable as the grace period approaches the end. As another example, an icon representing the document may take on a blurry appearance, which may worsen over time.

A “document,” may include any electronic file that stores textual information, with or without additional embedded information, such as, for example, an electronic version of printed text, such as an electronic book or an electronic article, scanned images of printed text, a web site or web page, a news group posting, a news article, a blog, an e-mail, a business listing, a web advertisement, etc.

In another implementation described herein, a user may have access to time-sensitive content, and the value of the time-sensitive content may decrease over time. Aging effects may be applied to the time-sensitive content, or to representations of the time-sensitive content, to provide an indication to the user that the value of the content is decreasing. As an example, an icon representing synchronization of a mobile device with a desktop device may take on an aged appearance over time, if the mobile device and the desktop device have not been synchronized for a particular period of time.

### Exemplary Devices

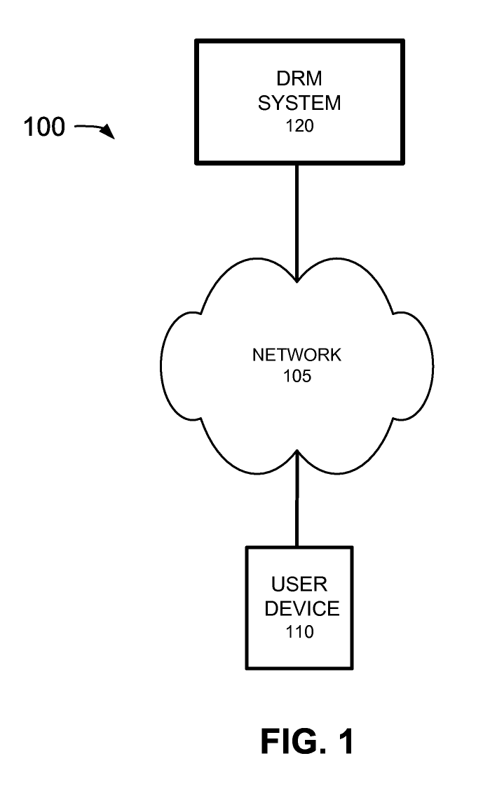

FIG. 1 is an overview of an exemplary system in which systems and methods described herein may be implemented. System 100 may include a network 105, a user device 110, and a digital rights management (DRM) system 120.

Network 105 may include a circuit-switched network or a packet-switched network. For example, network 105 may include one or more of a local area network (LAN), a wide area network (WAN), a metropolitan area network (MAN), a wireless network, such as a general packet radio service (GPRS) network, an ad hoc network, a public switched telephone network (PSTN), a subset of the Internet, any other network, or any combination thereof.

User device 110 may include any electronic device with communication capabilities. For example, user device 110 may include a mobile communication device, such as a cellular radiotelephone with or without a multi-line display; a personal communications system (PCS) terminal that may combine a cellular radiotelephone with data processing, facsimile and data communications capabilities; a PDA that may include a radiotelephone, pager, Internet/Intranet access, Web browser, organizer, calendar and/or a global positioning system (GPS) receiver; a laptop and/or palmtop receiver; a desktop device (e.g., a personal computer or workstation); a laptop computer; a personal digital assistant (PDA); a media playing device (e.g., an MPEG audio layer 3 (MP3) player, a digital video disc (DVD) player, a video game playing device); a television; a computer screen; a point-of-sale terminal; an industrial device (e.g., test equipment, control equipment); or any other device that may utilize an output device.

User device 110 may provide, via an output device, particular content to a user based on degradation specifications associated with the particular content. In one implementation, the degradation specifications may be stored in user device 110. In another implementation, the degradation specifications may be obtained from DRM system 120.

DRM system 120 may include one or more devices that store DRM specifications in association with particular content and may provide the particular content to user device 110 in accordance with the DRM specifications associated with the particular content. DRM system 120 may receive requests for the particular content from user device 110, and may provide the particular content in accordance with the DRM specifications. Additionally or alternatively, DRM system 120 may receive a request to implement DRM specifications for the particular content from another device. For example, a user may, via user device 110, request the particular content from a content server (not shown) hosting the content, and the content server may consult DRM system 120 for DRM specifications associated with the requested particular content. In response, the content server may provide the content to user device 110 based on the received DRM specifications.

DRM system 120 may store degradation specifications in association with the particular content. DRM system 120 may degrade the particular content, or a representation of the particular content, in accordance with the stored degradation specifications.

Although FIG. 1 shows exemplary devices of system 100, in other implementations, network system 100 may include fewer, different, or additional devices than depicted in FIG. 1. Additionally or alternatively, one or more devices of system 100 may perform one or more of the tasks described as being performed by one or more other devices of system 100.

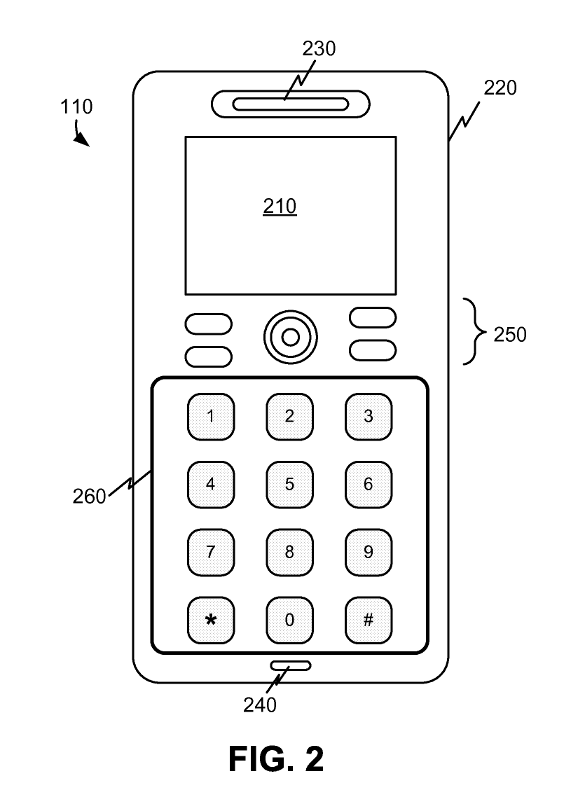

FIG. 2 is a diagram of an exemplary user device 110 in which systems and/or methods described herein may be implemented. Referring to FIG. 2, user device 110 may include a display 210, a housing 220, a speaker 230, a microphone 240, control buttons 250, and a keypad 260

Display 210 may include a component that provides visual information to the user. Display 210 may be a color display, such as a red, green, blue (RGB) display, a monochrome display or another type of display. Display 210 may include a touch sensor display that may be configured to receive a user input when the user touches display 210. For example, the user may provide an input to display 210 directly, such as via the user's finger, or via other input objects, such as a stylus. User inputs received via display 210 may be processed by components and/or devices operating in user device 110. The touch screen may permit the user to interact with user device 110 in order to cause user device 110 to perform one or more operations. In one exemplary implementation, display 210 may include a liquid crystal display (LCD) display. Display 210 may include a driver chip (not shown) to drive the operation of display 210.

Housing 220 may include a structure that protects the components of user device 100 from outside elements. Housing 220 may include a structure configured to hold devices and components used in user device 100, and may be formed from a variety of materials. For example, housing 220 may be formed from plastic, metal, or a composite, and may be configured to support display 210, speaker 230, microphone 240, control buttons 250, and keypad 260.

Speaker 230 may include a component that provides audible information to a user of user device 110. Speaker 230 may be located in an upper portion of user device 110, and may function as an ear piece when a user is engaged in a communication session using user device 110. Speaker 230 may also function as an output device for music and/or audio information associated with games, voicemails, and/or video images played on user device 110.

Microphone 240 may include a component that receives audible information from the user. Microphone 240 may include a device that converts speech or other acoustic signals into electrical signals for use by user device 110. Microphone 240 may be located proximate to a lower side of user device 110.

Control buttons 250 may include a component that permits the user to interact with user device 110 to cause user device 110 to perform one or more operations, such as place a telephone call, play various media, etc. For example, control buttons 250 may include a dial button, a hang up button, a play button, etc. Keypad 260 may include a telephone keypad used to input information into user device 110.

In an exemplary implementation, functionality of control buttons 250 and/or keypad 260 may be implemented via display 210, and control buttons 250 and keypad 260 may not be present in user device 100. In another implementation, control buttons 250 and keypad 260 may be present and different control buttons and keypad elements may be implemented via display 210 based on the particular mode in which user device 110 is operating. For example, when operating in a cell phone mode, functions associated with control buttons 250 and keypad 260 may be implemented using display 210, instead of, or in addition to, the functions being implemented using control buttons 250 and keypad 260. For example, a telephone keypad and control buttons associated with dialing, hanging up, etc., may be displayed via display 210. In other modes, functions associated with control buttons 250 and/or keypad 260 may not be implemented using display 210.

Although FIG. 2 shows exemplary components of user device 110, in other implementations, user device 110 may contain fewer, different, additional, or differently arranged components than depicted in FIG. 2. Additionally or alternatively, one or more components of user device 110 may perform one or more other tasks described as being performed by one or more other components of user device 110.

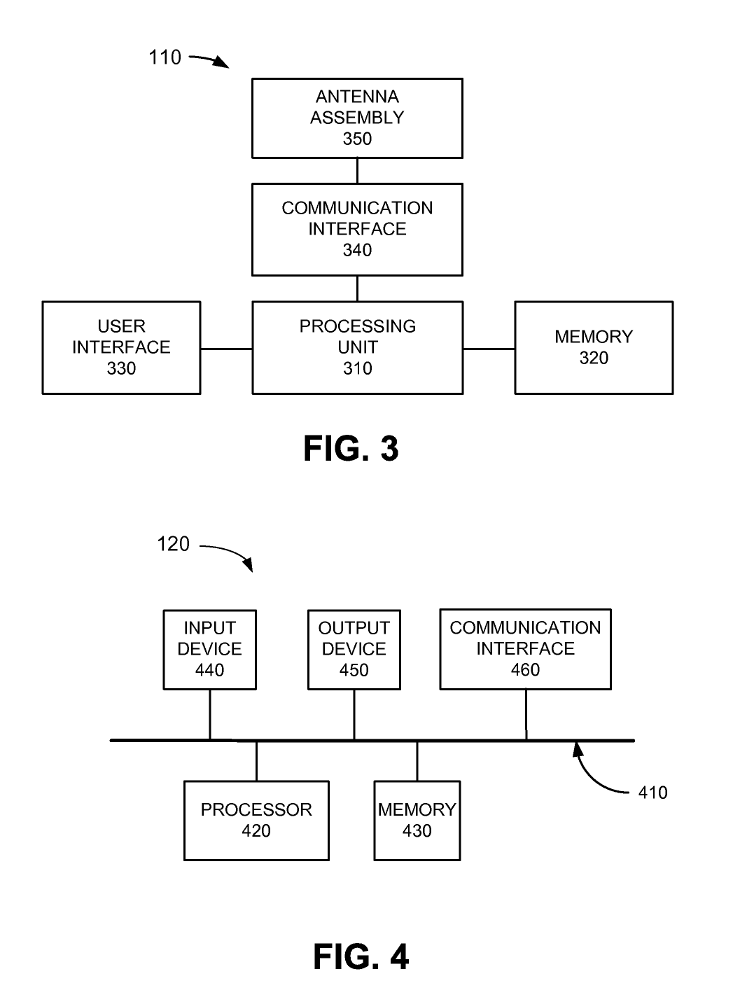

FIG. 3 illustrates a diagram of exemplary components of user device 110. As shown in FIG. 3, user device 110 may include a processing unit 310, a memory 320, a user interface 330, a communication interface 340, and an antenna assembly 350.

Processing unit 310 may include one or more processors, microprocessors, application specific integrated circuits (ASICs), field programmable gate arrays (FPGAs), or the like. Processing unit 310 may control operation of user device 100 and its components.

Memory 320 may include a random access memory (RAM), a read only memory (ROM), and/or another type of memory to store data and/or instructions that may be used by processing unit 310.

User interface 330 may include mechanisms for inputting information to user device 110 and/or for outputting information from user device 110. Examples of input and output mechanisms might include a speaker (e.g., speaker 230) to receive electrical signals and output audio signals; a camera lens to receive image and/or video signals and output electrical signals; a microphone (e.g., microphone 240) to receive audio signals and output electrical signals; buttons (e.g., a joystick, control buttons 250, or keys of keypad 260) to permit data and control commands to be input into user device 110; a display (e.g., display 210) to output visual information; and/or a vibrator to cause user device 110 to vibrate.

Communication interface 340 may include any transceiver-like mechanism that enables user device 110 to communicate with other devices and/or systems. For example, communication interface 340 may include a modem or an Ethernet interface to a local area network (LAN). Communication interface 340 may also include mechanisms for communicating via a network, such as a wireless network. For example, communication interface 340 may include, for example, a transmitter that may convert baseband signals from processing unit 310 to radio frequency (RF) signals and/or a receiver that may convert RF signals to baseband signals. Alternatively, communication interface 340 may include a transceiver to perform functions of both a transmitter and a receiver. Communication interface 240 may connect to antenna assembly 350 for transmission and/or reception of the RF signals.

Antenna assembly 350 may include one or more antennas to transmit and/or receive RF signals over the air. Antenna assembly 350 may, for example, receive RF signals from communication interface 340 and transmit them over the air and receive RF signals over the air and provide them to communication interface 340. In one implementation, for example, communication interface 340 may communicate with a network, such as network 105.

As described herein, user device 110 may perform certain operations in response to processing unit 310 executing software instructions contained in a computer-readable medium, such as memory 320. A computer-readable medium may be defined as a physical or logical memory device. A logical memory device may include memory space within a single physical memory device or spread across multiple physical memory devices. The software instructions may be read into memory 320 from another computer-readable medium or from another device via communication interface 340. The software instructions contained in memory 320 may cause processing unit 310 to perform processes that will be described later. Alternatively, hardwired circuitry may be used in place of or in combination with software instructions to implement processes described herein. Thus, implementations described herein are not limited to any specific combination of hardware circuitry and software.

Although FIG. 3 shows exemplary components of user device 110, in other implementations, user device 110 may contain fewer, different, additional, or differently arranged components than depicted in FIG. 3. Additionally or alternatively, one or more components of user device 110 may perform one or more other tasks described as being performed by one or more other components of user device 110.

DRM system 120 may include one or more server devices. FIG. 4 is a diagram illustrating exemplary components of a server device associated with DRM system 120, in which systems and/or methods described herein may be implemented. As illustrated, DRM system 120 may include a bus 410, a processor 420, a memory 430, an input device 440, an output device 450, and/or a communication interface 460.

Bus 410 may include a path that permits communication among the components of DRM system 120.

Processor 420 may include one or more processors, microprocessors, ASICs, FPGAs, or other types of processors that may interpret and execute instructions, programs, or data structures. Processor 220 may control operation of DRM system 120 and its components.

Memory 430 may include a RAM or another type of dynamic storage device that may store information and/or instructions for execution by processor 420; a ROM or another type of static storage device that may store static information and/or instructions for use by processor 420; a flash memory (e.g., an EEPROM) device for storing information and/or instructions; and/or some other type of magnetic or optical recording medium and its corresponding drive. Memory 430 may also be used to store temporary variables or other intermediate information during execution of instructions by processor 420. Instructions used by processor 420 may also, or alternatively, be stored in another type of computer-readable medium accessible by processor 420.

Input device 440 may include a mechanism that permits an operator to input information to DRM system 120, such as a keyboard, a mouse, a pen, a microphone, voice recognition and/or biometric mechanisms, a touch screen, etc. Output device 450 may include a mechanism that outputs information to the operator, including a display, a printer, a speaker, etc.

Communication interface 460 may include any transceiver-like mechanism that enables DRM system 120 to communicate with other devices and/or systems. For example, communication interface 460 may include a modem or an Ethernet interface to a LAN. Communication interface 460 may also include mechanisms for communicating via a network, such as a wireless network. For example, communication interface 460 may include, for example, a transmitter that may convert baseband signals from processor 420 to RF signals and/or a receiver that may convert RF signals to baseband signals. Alternatively, communication interface 460 may include a transceiver to perform functions of both a transmitter and a receiver.

As described herein, DRM system 120 may perform certain operations in response to processor 420 executing software instructions contained in a computer-readable medium, such as memory 430. The software instructions may be read into memory 430 from another computer-readable medium, such as a magnetic or optical recording medium and its corresponding drive, or from another device via communication interface 460. The software instructions contained in memory 430 may cause processor 420 to perform processes described herein. Alternatively, hardwired circuitry may be used in place of or in combination with software instructions to implement processes described herein. Thus, implementations described herein are not limited to any specific combination of hardware circuitry and software.

Although FIG. 4 shows exemplary components of DRM system 120, in other implementations, DRM system 120 may contain fewer, different, differently arranged, or additional components than depicted in FIG. 4. Additionally or alternatively, one or more components of DRM system 120 may perform one or more other tasks described as being performed by one or more other components of DRM system 120.

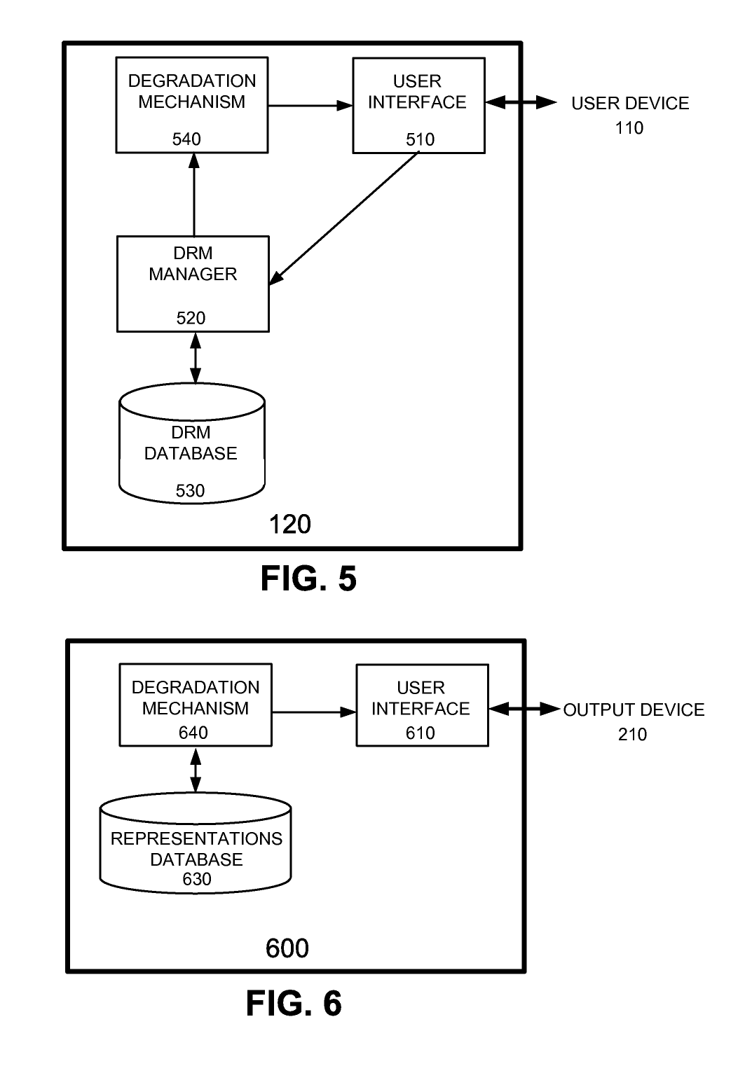

FIG. 5 is a diagram of exemplary functional components of DRM system 120 of FIG. 4. DRM system 120 may include a user interface 510, a DRM manager 520, a DRM database 530, and a degradation mechanism 540.

User interface 510 may provide content to user device 110. User interface 510 may determine a particular format that is applicable to user device 110 and provide the content based on the particular format. In one implementation, user interface 510 may provide content that has been degraded according to content aging specifications stored in DRM database 530. In another implementation, user interface 510 may provide the content aging specifications to user device 110, and user device 110 may perform operations on particular content to degrade the particular content according to the received content aging specifications.

DRM manager 520 may retrieve DRM specifications, from DRM database 530, in associated with particular content, and may determine access rights for the particular content in relation to a user or a group of users. DRM manager 520 may detect that access rights have expired for the particular content and may retrieve content aging specifications for the particular content. DRM manager may provide the content aging specifications to degradation mechanism 540.

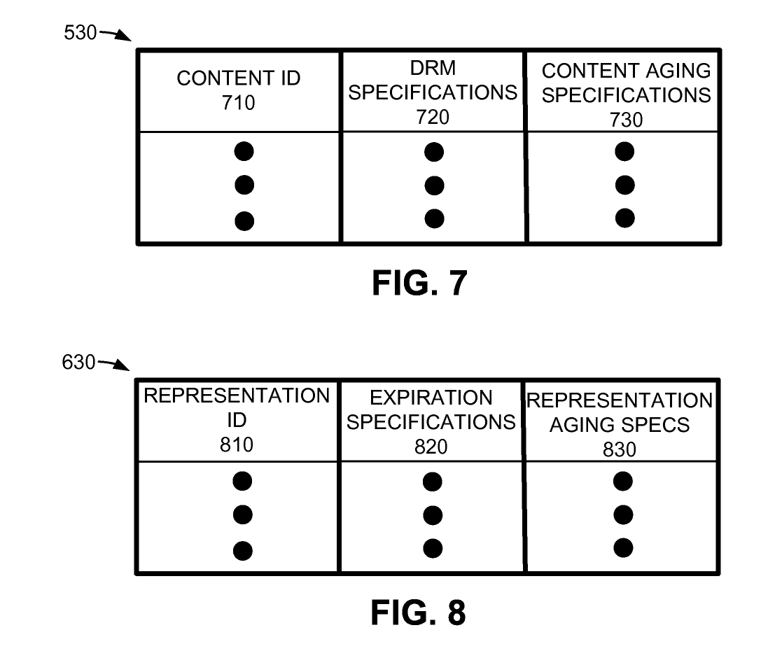

DRM database 530 may store DRM specifications and/or content aging specifications associated with particular content. Exemplary fields that may be stored in DRM database 530 are discussed below with respect to FIG. 7.

Degradation mechanism 540 may age content, or a representation of the content, based on content aging specifications received from DRM manager 520. For example, degradation mechanism 540 may apply image processing techniques to an image or to an image representation of a document to make the image or the image representation of the document appear older, more blurry, lighter, or otherwise changed to indicate, to the user, that the user's rights with respect to the content have expired. Degradation mechanism 540 may apply the image processing techniques multiple times over a period of time, each time increasing the effect. The rate at which the effect is increased may be determined by the content aging specifications received from DRM manager 520.

As another example, degradation mechanism 540 may apply image processing techniques to an icon or a link representing a document or an image. As a further example, degradation mechanism 540 may apply signal processing techniques to an audio or video file to make the audio of the audio or video sound muffled, may lower the volume of the audio, may introduce noise or static into the audio or video, or may otherwise change the audio to indicate, to the user, that the user's rights with respect to the audio or video file have expired. As yet another example, rather than performing image processing or signal processing techniques on the content, degradation mechanism 540 may provide less than 100% of the content after the user's rights have expired. Degradation mechanism 540 may decrease the percentage of content that is provided to the user over time. The rate at which the percentage of available content is decreased may be determined by the content aging specifications received from DRM manager 520.

Although FIG. 5 shows exemplary functional components of DRM system 120, in other implementations, DRM system 120 may contain fewer, different, differently arranged, or additional functional components than depicted in FIG. 5. Additionally or alternatively, one or more functional components of DRM system 120 may perform one or more other tasks described as being performed by one or more other functional components of DRM system 120.

FIG. 6 is a diagram of exemplary functional components of a content aging application 600 that may be implemented in user device 110 of FIG. 3. Content aging application 600 may include a user interface 610, a representations database 630, and a degradation mechanism 640. Content aging application 600 may receive content that has been previously aged and provided by DRM system 120. Additionally or alternatively, content aging application 600 may age content stored on user device 110 based on content aging specifications received from DRM system 120. Additionally or alternatively, content aging application 600 may age a representation of content, either stored in user device 110 or retrieved from another device, based on content aging specifications received from DRM system 120.

Content aging application 600 may receive, from a content provider, content that includes DRM specifications with the content. Content aging application 600 may determine when access rights to the content expire based on the DRM specifications included with the content, and may apply degradation effects to the content based on content aging specifications included within the DRM specifications included with the content.

Additionally or alternatively, content aging application 600 may age a representation of content stored in user device 110 that may not be associated with DRM specifications, but that may be time-sensitive. For example, content aging application 600 may age an icon associated with synchronizing user device 110 with a desktop computer, if synchronization between user device 110 and the desktop computer has not been performed for a particular period of time. As another example, content aging application 600 may age an icon associated with the user's contacts, if the contacts have not been updated for a particular period of time. As yet another example, content aging application 600 may age an icon or a button associated with a data feed (e.g., an RSS feed), if the data feed has not been updated for a particular period of time.

User interface 610 may provide content to an output device. For example, user interface 610 may provide content to display 210 or to speaker 240. The provided content may have been received from degradation mechanism 640 or from communication interface 340 (e.g., received from DRM system 120).

Representations database 630 may store representation aging specifications associated with particular content. Exemplary fields that may be stored in representations database 630 are discussed below with respect to FIG. 8.

Degradation mechanism 640 may degrade content based on content aging specifications stored in representations database 630 or received from another device (e.g., DRM system 120). For example, degradation mechanism 640 may apply image processing techniques to an image or to an image representation of a document to make the image or the image representation of the document appear older, more blurry, lighter, or otherwise changed to indicate to the user that the user's rights with respect to the content have expired. Degradation mechanism 640 may apply the image processing techniques multiple times over a period of time, each time increasing the effect. The rate at which the effect is increased may be determined based on content aging representations received from DRM system 120.

As a further example, degradation mechanism 640 may apply signal processing techniques to an audio or video file to make the audio of the audio or video sound muffled, may lower the volume of the audio, may introduce noise or static into the audio or video, or may otherwise change to audio to indicate to the user that the user's rights with respect to the audio or video file have expired. As yet another example, rather than performing image processing or signal processing techniques on the content, degradation mechanism 640 may provide less than 100% of the content after the user's rights have expired. Degradation mechanism 640 may decrease the percentage of content that is provided to the user over time. The rate at which the percentage of available content is decreased may be determined by the content aging specifications received from DRM manager 520.

As another example, degradation mechanism 640 may apply image processing techniques to an icon or a link representing a document, an image, or an audio or video file.

Degradation mechanism 640 may detect that particular content has not been updated for a particular period time, or that the particular content has expired or is beginning to expire. In response, degradation mechanism 640 may initiate degradation processing on a representation of the content. Degradation mechanism 640 may apply image processing techniques to an icon or a link representing the expired or un-updated content. Additionally or alternatively, degradation mechanism 640 may provide an indication on the icon or the link, or in proximity to the icon or the link, indicating a date when the content was last updated or when the content has expired, and/or an indication of how much time has passed since the content was last updated or when the content expired.

Although FIG. 6 shows exemplary functional components of content aging application 600, in other implementations, content aging application 600 may contain fewer, different, differently arranged, or additional functional components than depicted in FIG. 6. Additionally or alternatively, one or more functional components of content aging application 600 may perform one or more other tasks described as being performed by one or more other functional components of content aging application 600.

FIG. 7 is a diagram of an exemplary data structure that may be implemented in DRM database 530. DRM database 530 may include a content identification (ID) field 710, a DRM specifications field 720, and a content aging specifications field 730.

Content ID field 710 may store an identifier that identifies particular content. For example, content ID field 710 may store a name of a document, image, or audio or video file, or a unique string that identifies the document, image, or audio or video file.

DRM specifications field 720 may include information specifying access rights associated with the content identified in content ID field 710. The information may identify a particular user or a group of users, and/or may specify how long the particular user or group of users has access rights to the content. For example, the information may include an expiration date at which the access rights expire.

Content aging specifications field 730 may specify whether to apply content aging to the content after access rights have expired. Content aging specifications field 730 may specify how to degrade the content and how long to degrade the content. For example, content aging specifications field 730 may specify a particular image processing technique or algorithm, or a particular signal processing technique or algorithm that is to be applied to the content to degrade the content. As another example, content aging specifications field 730 may specify that portions of the content are to be deleted over a particular time period. Content aging specifications field 730 may specify a particular degradation function that may define at what rate the content is to be degraded and/or over how long a period of time the content is to be degraded.

FIG. 8 is a diagram of an exemplary data structure that may be implemented in representations database 630. Representations database 630 may include a representation identification (ID) field 810, expiration specifications field 820, and a representation aging specifications field 830.

Representation ID field 810 may identify a particular representation of content. For example, representation ID field 810 may identify a particular icon or link to time-sensitive content. Examples of such icons may include a contacts icon that activates an application that manages contacts, a synchronization icon that synchronizes two devices, a calendar icon that activates a calendar application, or a button or icon that is associated with a data feed. For example, a user may have subscribed to an RSS feed, but may not have scheduled any updates. The icon associated with the RSS feed may indicate that no update has been performed by being changed to an aged icon.

Expiration specifications field 820 may include information that specifies when content associated with representation ID field 810 is to be considered expired or out of date. For example, expiration specifications field 820 may include a date when the content associated with the representation was last accessed or last updated, as well as an indication of how much time is to be allotted after the date before the content is to be considered expired or out of date.

Representation aging specifications field 830 may specify whether to apply content aging to the representation after the content associated with the representation is considered expired or out of date. Content aging specifications field 830 may specify how to degrade the representation. For example, in one implementation, content aging specifications field 830 may specify a particular image processing technique or algorithm that is to be applied to the representation to degrade the representation. In another implementation, content aging specifications field 830 may store a series of representations that are to be provided as the content associated with the representation ages. For example, content aging specifications field 830 may store a particular number of icons (e.g., three icons), where a first icon is a non-degraded icon, a second icon is a slightly degraded version of the first icon, a third icon is a more degraded version of the first icon, etc. Content aging specifications field 830 may specify a particular degradation function that may define at what rate the content is to be degraded and/or over how long a period of time the content is to be degraded, or at what rate a particular representation is to be replaced with a more degraded version of the representation.

Although FIGS. 7 and 8 show exemplary data fields that may be stored in DRM database 530 and representations database 630, in other implementations, DRM database 530 and representations database 630 may include fewer, different, differently arranged, or additional data fields than depicted in FIGS. 7 and 8. Additionally or alternatively, one or more data fields of DRM database 530 and representations database 630 may store information described as being stored in one or more data fields of DRM database 530 or representations database 630.

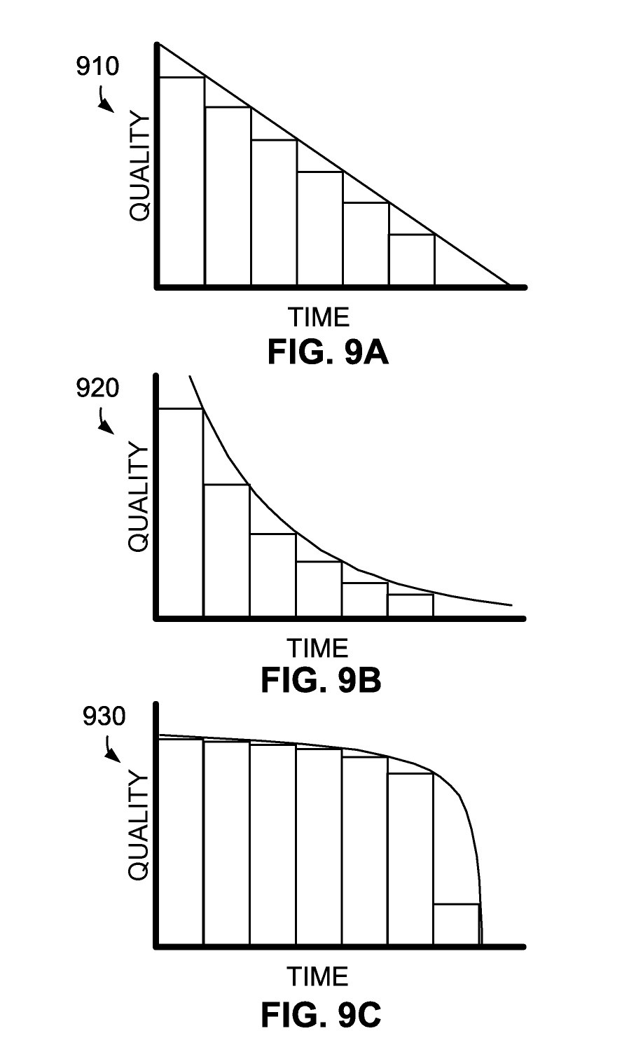

FIGS. 9A-9C illustrate diagrams of exemplary degradation functions according to implementations described herein. Implementations described herein may degrade content or representations of content according to particular degradation functions.

FIG. 9A illustrates a diagram representing a first exemplary degradation function 910. First exemplary degradation function 910 may include a linear function that, when applied to degradation effects on content, degrades quality of content linearly over time. First degradation function 910 may be applied to content or a representation of content when a linear degradation function is desirable, such as when a user's access rights expire and the user is to be continuously reminded during a grace period that the user will soon lose all access rights. When content is degraded in a linear fashion, a user may continue to notice that the content is being degraded.

FIG. 9B illustrates a diagram of a second exemplary degradation function 920. Second exemplary degradation function 920 may include an exponential decay function that, when applied to degradation effects on content, degrades quality of content exponentially over time. Second degradation function 920 may be applied to content or a representation of content when an exponential degradation function is desirable, such as when value of the content drops quickly after the content has expired or is out of date. For example, if it is determined that a user has not updated a calendar, an icon associated with the calendar may be degraded quickly at first to alert the user. After an initial quick degradation of the icon, the icon may be degraded slowly and the degradation may taper off, as the object of alerting the user has been accomplished. Furthermore, the icon may need to remain recognizable, so that the user may still locate and activate the icon if desired.

FIG. 9C illustrates a diagram of a third exemplary degradation function 930. Third exemplary degradation function 930 may include a parabolic function that, when applied to degradation effects on content, degrades quality of content over time in a parabolic fashion. Third degradation function 930 may be applied to content or a representation of content when a parabolic degradation function is desirable, such as when it is desirable to give a user a grace period during which the user may continue to access the content, but where degradation of the content to a larger extent may make the content unusable. For example, if a document is degraded too much, the document may become unreadable, or if an audio file is degraded too much, the audio file may become un-listenable.

While FIGS. 9A-9C illustrate exemplary degradation functions, other implementations may use different degradation functions. In yet other implementations, content aging specifications may not include a degradation function or a representation of a degradation function, and content aging specifications may be provided using another format or representation.

### Exemplary Processes

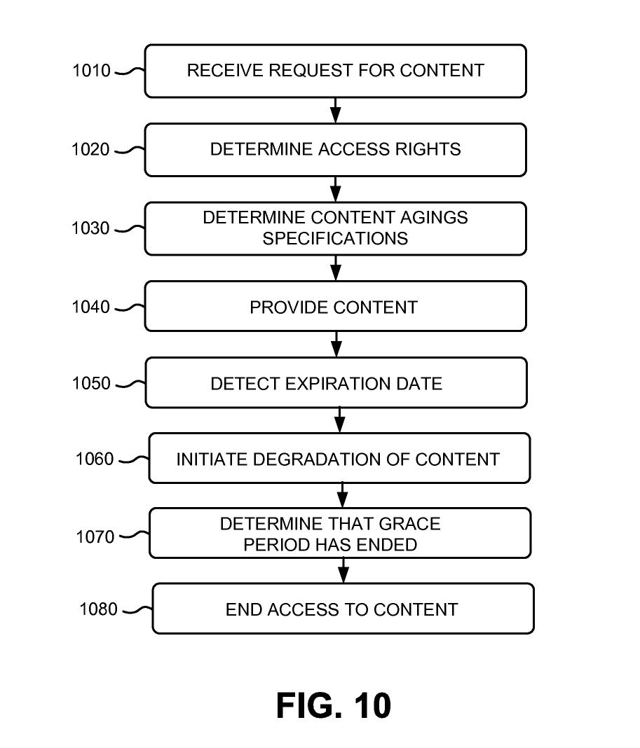

FIG. 10 is a flow graph of an exemplary process for initiating degradation of content according to an implementation described herein. In one implementation, the process of FIG. 10 may be performed by one or more servers comprising DRM system 120. In other implementations, the process of FIG. 10 may be performed by a different device or a group of devices (e.g., user device 110).

The process of FIG. 10 may include receiving a request for content (block 1010). For example, a user may send a request for content across network 105 via user device 110. For example, a user may access a website and purchase a subscription to access the contents of the website. Access rights may be determined (block 1020). For example, DRM manager 520 may receive information from the website that the user has purchased a subscription and may update DRM database 530 with the information, which may include information about when the user's subscription will expire. Content aging specifications may be determined (block 1030). For example, DRM manager 520 may receive information from the website indicating a length of a grace period that the user is to be given, as well as a degradation function that determines how the content is to be degraded when the content is presented to the user.

Content may be provided (block 1040). For example, the user may continue to access the content of the website. An expiration date may be detected (block 1050). For example, DRM manager 520 may detect that the user's subscription has expired. Degradation of content may be initiated (block 1060). For example, when a user requests content from the website, the content may be provided to degradation mechanism 540. Degradation mechanism 540 may degrade the content according to content aging specifications 730 and provide the degraded content to the user.

A determination may be made that a grace period associated with the access rights has ended (block 1070). For example, DRM manager 520 may determine that the user's grace period is over by accessing content aging specifications field 730 associated with the content. In response to determining that the grace period has ended, access to the content may be ended (block 1080). For example, when the user attempts to access the content, DRM manager 520 may provide a notice to the user that the content is no longer available to the user. As an alternative to blocks 1070 and 1080, degradation of the content may proceed at a rate such that when the grace period ends, the degradation has proceeded to a point at which the content becomes inaccessible. For example, a document may have become unreadable, an audio file may have become un-listenable, or a video file may have become unwatchable as a result of the degradation of the content.

As another example, content aging specification 600 may receive content from a content provider. The content may include associated DRM specifications. The associated DRM specifications received with the content may include an expiration date, a grace period, and particular degradation effects, such as a particular degradation function. Content aging specification 600 may degrade the content, or a representation of the content, based on the DRM specifications that were received along with the content.

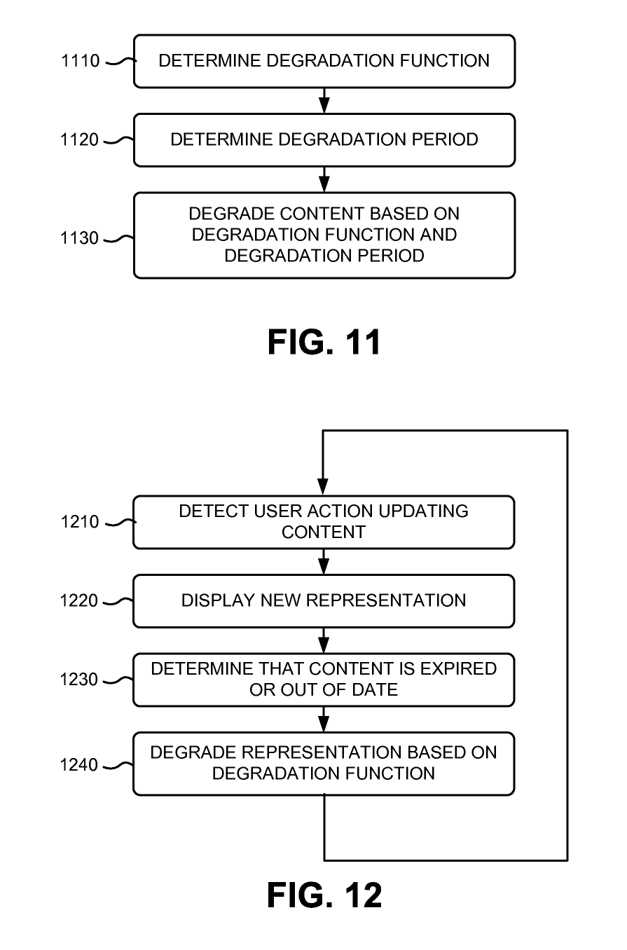

FIG. 11 is a flow graph of a first exemplary process for degrading content according to an implementation described herein. In one implementation, the process of FIG. 11 may be performed by one or more servers comprising DRM system 120. In other implementations, the process of FIG. 11 may be performed by a different device or a group of devices.

The process of FIG. 11 may include determining a degradation function (block 1110). For example, DRM manager 520 may determine a particular degradation function to be applied to content or to a representation of content, such as degradation function 910, degradation function 920, or degradation function 930. In one implementation, DRM manager 520 may determine a particular degradation function based on a type of content or a particular content provider. For example, DRM manager 520 may include a table that associates content types or content providers with degradation functions. In another implementation, DRM manager 520 may receive a degradation function selection from a content provider.

A degradation period may be determined (block 1120). For example, DRM manager 520 may determine a particular degradation period over which the determined degradation function is to be applied to the content or to the representation of content. In one implementation, DRM manager 520 may determine a particular degradation period based on a type of content, or based on a particular content provider. For example, DRM manager 520 may include a table that associates content types or content providers with degradation periods. In another implementation, DRM manager 520 may receive a degradation function selection from a content provider.

Content may be degraded based on the degradation function and based on the degradation period (block 1130). For example, degradation mechanism 540 (or degradation mechanism 640) may degrade the content, based on the determined degradation function and based on the determined degradation period, by applying an image processing algorithm or signal processing algorithm to the content.

FIG. 12 is a flow graph of a second exemplary process for degrading content according to an implementation described herein. In one implementation, the process of FIG. 12 may be performed by user device 110. In other implementations, the process of FIG. 12 may be performed by a different device or a group of devices.

The process of FIG. 12 may include detecting a user action of updating content (block 1210). For example, content aging application 600 may detect that a user has updated particular content, such as the contacts stored on user device 110. A new representation may be displayed (block 1220). For example, user interface 610 may display a representation of the content that is not aged, such as a contacts icon that has not been degraded. A determination may be made that the content associated with the representation is out of date or expired (block 1230). For example, content aging application 600 may detect, by consulting representations database 630, that the user has not updated the contacts stored on user device 100. The determination may be made based on an elapsed period of time. Additionally or alternatively, the determination may be made in response to a trigger event. For example, a user may receive a phone call from another user that is not in the user's contacts list. If the user does not include the caller in the user's contacts, content aging application 600 may determine that the user's contacts are out of date.

The displayed representation may be degraded based on a degradation function (block 1240). For example, degradation mechanism 640 may replace an un-degraded contact icon with a degraded contact icon to indicate that the user may want to update the user's contacts.

### EXAMPLES

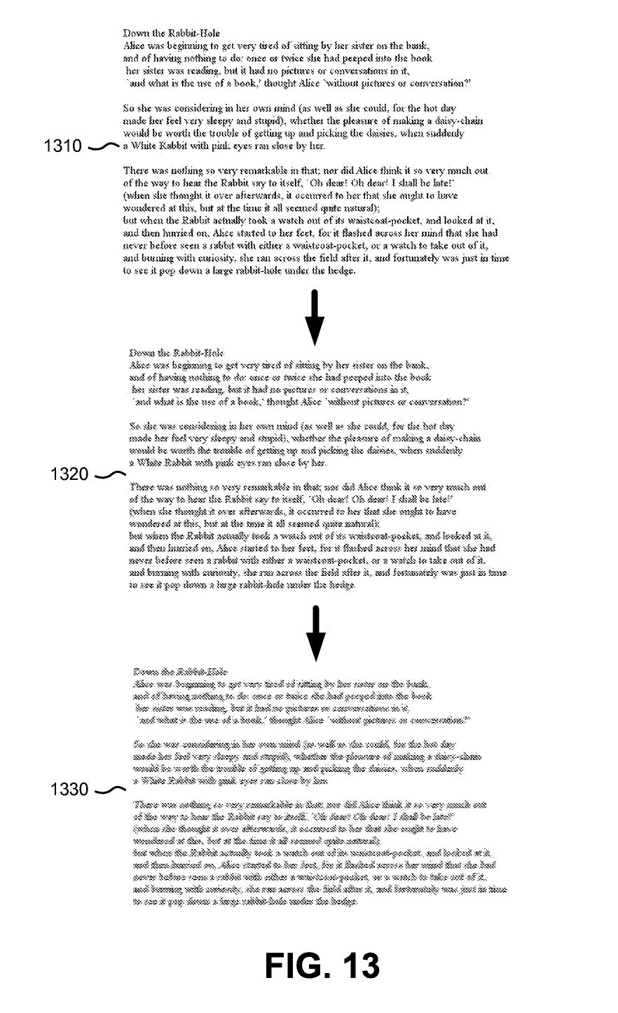

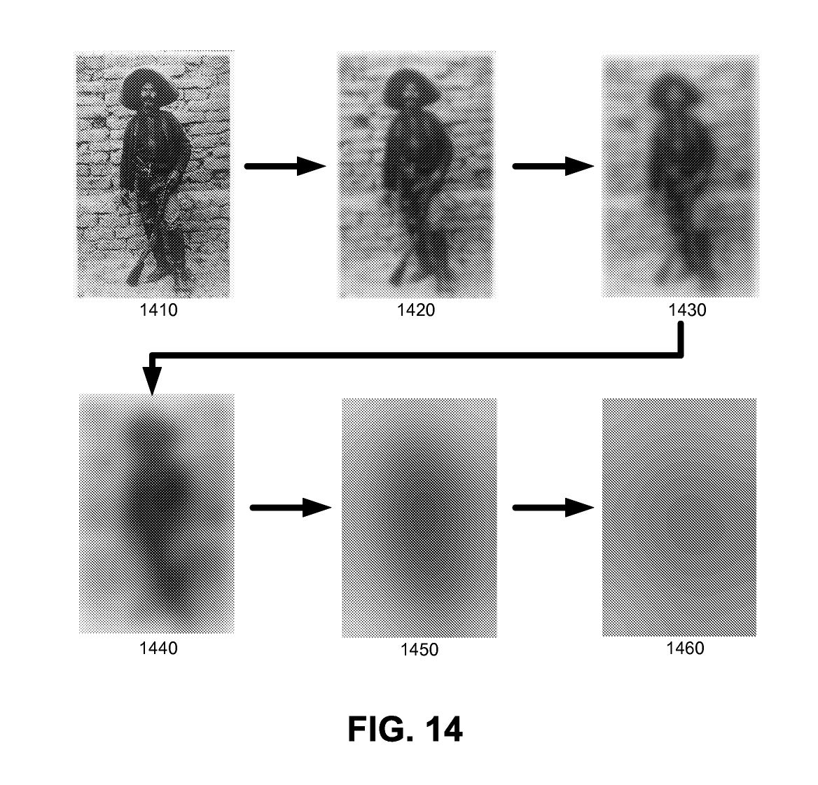

FIGS. 13 and 14 illustrate examples of content being aged over a period of time. FIG. 13 illustrates a first example of content being degraded according to an implementation described herein. FIG. 13 illustrates a portion of document 1310. Document 1310 may include, for example, a portable document format (PDF) document, or images of pages from a book.

After a user's access rights to document 1310 have expired, document 1310 may be degraded to degraded document 1320. For example, document 1310 may be processed using a filter that makes the print of degraded document 1320 appear wavy. Degraded document 1320 may be readable, and the user may be aware that the user's rights have expired because of the appearance of degraded document 1320. After a particular period of time has passed, degraded document 1320 may be further degraded to degraded document 1330. For example, degraded 1320 may be further processed using the same filter to make the print appear wavier than the print in degraded document 1320. At this point, degraded document 1330 may be very hard to read.

FIG. 14 illustrates a second example of content being degraded according to an implementation described herein. FIG. 14 illustrates an image 1410. Image 1410 may, for example, be an image file, an image from a book, or may be a still image from a video file. As an example, a book that includes a large number of images may be degraded in such a fashion that all the images are degraded similarly to image 1410, while the text remains readable. Alternatively, the text may be rendered unreadable while the images are not degraded. As another example, if image 1410 is a still image from a video file, such as a movie, every nth frame of the video file may be degraded in a similar fashion. Alternatively, every nth frame of the video file may be deleted. As yet another example, a user may have a paid subscription to a website that hosts image 1410. After a user's rights have expired in association with image 1410, image 1410 may go through a series of degradations over a particular period of time and the user may be presented with degraded images 1420-1460 over the particular period of time whenever the user accessed image 1410.

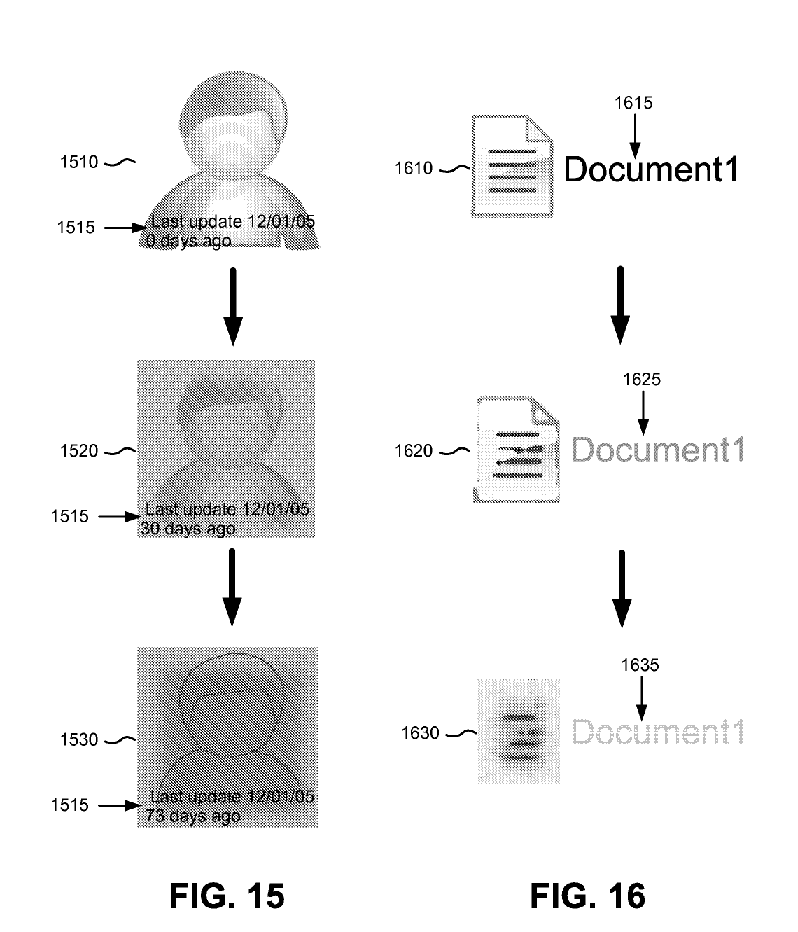

FIGS. 15 and 16 illustrate examples of representations of content being aged over a period of time. FIG. 15 illustrates a third example of content being degraded according to an implementation described herein. FIG. 15 illustrates contacts icon 1510. Contacts icon 1510 may activate a contacts application. Contacts icon 1510 may include an update indication 1515 that includes information about the date of the last update and/or the amount of time that has elapsed since the last update. If it is determined that the contacts application is out of date, contacts icon 1510 may be replaced with aged contacts icon 1520. After a particular period of time, aged contacts icon 1520 may be replaced with aged contacts icon 1530. Aged contacts icon 1530 may appear more aged than aged contacts icon 1520. However, aged contacts icon 1530 may still be recognizable as a contacts icon so that a user may still locate and activate the contacts application.

FIG. 16 illustrates a fourth example of content being degraded according to an implementation described herein. FIG. 16 illustrates a document icon 1610. Documents icon 1610 may represent a document to which the user has access rights. Filename 1615 may include a name associated with the document and may appear next to icon 1610. After the user's access rights have expired, document icon 1610 may be changed to degraded document icon 1620 and filename 1615 may be changed to faded filename 1625. After a particular period of time, degraded document icon 1620 may be changed to degraded document icon 1630 and faded filename 1625 may be changed to faded filename 1635.

### CONCLUSION

The foregoing description provides illustration and description, but is not intended to be exhaustive or to limit the invention to the precise form disclosed. Modifications and variations are possible in light of the above teachings or may be acquired from practice of the invention.

For example, while examples of content, that may be aged based on implementations described herein, include documents, images of documents, images, audio or video files, or representations of content such as icons or links, the implementations described herein may be applied to any digitally stored information. For example, the implementations described herein may be applied to computer programs, such as software code, applications, or script files.

As another example, while aging of content or a representation of content has been described as beginning after access rights have expired or after content has been determined to be expired or out of date, aging may be applied before access rights have expired or before content has been determined to be expired or out of date, in order to provide a warning to a user.

As yet another example, while series of blocks have been described with respect to FIGS. 10, 11, and 12, the order of the blocks may be modified in other implementations. Further, non-dependent blocks may be performed in parallel.

Furthermore, it is to be understood that methods of degrading content or representations of content within the scope of the systems and methods described herein may be provided. Any processing technique that changes the appearance of content or a representation of content may be implemented.

Still further, aspects have been mainly described in the context of a mobile communication device. As discussed above, the systems and methods described herein may be used with any type of device that includes an output device. It should also be understood that particular devices discussed above are exemplary only and other devices may be used in alternative implementations to generate the desired information.

It will be apparent that aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

It should be emphasized that the term “comprises/comprising” when used in this specification is taken to specify the presence of stated features, integers, steps, or components, but does not preclude the presence or addition of one or more other features, integers, steps, components, or groups thereof.

Even though particular combinations of features are recited in the claims and/or disclosed in the specification, these combinations are not intended to limit the description. In fact, many of these features may be combined in ways not specifically recited in the claims and/or disclosed in the specification.

No element, act, or instruction used in the description of the present application should be construed as critical or essential to the description unless explicitly described as such. Also, as used herein, the article “a” is intended to include one or more items. Where only one item is intended, the term “one” or similar language is used. Further, the phrase “based on,” as used herein is intended to mean “based, at least in part, on” unless explicitly stated otherwise.

What is claimed is:

1. A device, comprising:
a memory to store instructions; and
a processor to execute the instructions to:
determine that access rights, associated with a particular user in relation to particular content, have expired;
degrade an appearance of the particular content or a representation of the particular content, where the degradation is amplified over a grace period that commences upon the expiration of the access rights, in response to determining that the access rights have expired;
determine that the grace period associated with the expired access rights has ended; and
end access to the particular content, in response to determining that the grace period has ended.

2. The device of claim 1, where the processor is to degrade the particular content in response to the particular user accessing the particular content.

3. The device of claim 1, where the particular content includes at least one of a document, an image, an audio file, or a video file.

4. The device of claim 1, where degrading an appearance of the particular content or a representation of the particular content includes degrading the representation of the particular content, where the representation of the particular content includes at least one of an icon associated with the particular content or a link associated with the particular content.

5. The device of claim 1, where the processor is to degrade the content based on content aging specifications associated with the particular content.

6. The device of claim 5, where the processor is further to:
receive the content aging specifications from a content provider associated with the particular content.

7. The device of claim 5, where the content aging specifications include a degradation function that includes a linear degradation function, an exponential decay degradation function, or a parabolic degradation function.

8. The device of claim 1, where the processor is further to:
determine that time-sensitive content associated with the particular user is expired or is out of date; and
degrade a representation of the time-sensitive content, where the degradation is amplified over a particular period of time, in response to determining that the time-sensitive content has expired or is out of date.

9. The device of claim 8, where the representation of the time-sensitive content includes one of a synchronization icon, a contacts icon, or an icon associated with a data feed.

10. A method performed by a computer device, the method comprising:
determining, using a processor of the computer device, that access rights, associated with a particular user in relation to particular content, have expired;
degrading, using the processor, an appearance of the particular content or a representation of the particular content, where degrading effects associated with the degrading are amplified over a grace period that commences upon the expiration of the access rights, in response to determining that the access rights have expired;
determining, using the processor, that the grace period associated with the expired access rights has ended; and
ending, using the processor, access to the particular content, in response to determining that the grace period has ended.

11. The method of claim 10, where the particular content includes at least one of a document, an image, an audio file, or a video file.

12. The method of claim 10, where degrading an appearance of the particular content or a representation of the particular content includes degrading the representation of the particular content, where the representation of the particular content includes at least one of an icon associated with the particular content or a link associated with the particular content.

13. The method of claim 10, further comprising:
determining content aging specifications associated with the particular content.

14. The method of claim 13, where the content aging specifications are determined based on at least one of a type of the particular content or a content provider associated with the particular content.

15. The method of claim 13, where the content aging specifications include a degradation function that includes a linear degradation function, an exponential decay degradation function, or a parabolic degradation function.

16. The method of claim 10, where the degrading the particular content or a representation of the particular content comprises applying a particular image processing algorithm or a particular signal processing algorithm to the particular content or a representation of the particular content.

17. The method of claim 10, further comprising:
determining that time-sensitive content associated with the particular user is expired or is out of date; and
degrading a representation of the time-sensitive content, where the degrading is amplified over a particular period of time, in response to determining that the time-sensitive content has expired or is out of date.

18. The method of claim 17, where the representation of the time-sensitive content includes one of a synchronization icon, a contacts icon, or an icon associated with a data feed.

19. The method of claim 17, where the degrading of a representation of the time-sensitive content includes replacing the representation of the time-sensitive content with a representation of the time-sensitive content that has an aged appearance.

20. One or more memory devices storing instructions executable by one or more processors, the one or more memory devices comprising:
one or more instructions to determine that access rights, associated with a particular user in relation to particular content, have expired;
one or more instructions to degrade an appearance of the particular content or a representation of the particular content, where the degradation is amplified over a grace period that commences upon expiration of the access rights, in response to determining that the access rights have expired;
one or more instructions to determine that the grace period associated with the expired access rights has ended; and
one or more instructions to end access to the particular content, in response to determining that the grace period has ended.
